(19) United States
(12) Patent Application Publication
(10) Pub. No.: US 2012/0049790 A1
(43) Pub. Date: Mar. 1, 2012

(54) WEARABLE ELECTRONIC DEVICE WITH AUTOMATIC CHARGING FUNCTION

(75) Inventor: YANG-LIANG WU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/916,630

(22) Filed: Oct. 31, 2010

(30) Foreign Application Priority Data
Aug. 31, 2010 (CN) 201010268138.1

(51) Int. Cl. H02J 7/00

(52) U.S. Cl. 320/108

(57) ABSTRACT

A wearable electronic device with an automatic rechargeable function includes a rechargeable battery, a base, a cover, a magnet slidably connected to inside of the base, and a converting circuit. The cover is engaged with the base, and includes at least one conducting winding electrically connected to the rechargeable battery. When the wearable electronic device is moved to drive the magnet to slide inside of the base, the magnetic flux density passing through the at least one conducting winding is changed, causing an induction current to be generated. The converting circuit is able to convert the induction current to direct current.

### BACKGROUND

1. Technical Field

The present disclosure relates to wearable electronic devices and, particularly, to a wearable electronic device with an automatic charging function.

2. Description of Related Art

Wearable electronic devices, such as wristwatch, usually include a rechargeable battery for supplying power. When the rechargeable battery has no power, it is needed to use an independent charger to charge the battery from an AC power source, which is inconvenient especially when a user does not have a charger handy.

Therefore, what is needed is a wearable electronic device with an automatic charging function to overcome the described shortcoming.

### BRIEF DESCRIPTION OF THE DRAWINGS

FIG. 1 is an isometric view of a wearable electronic device with an automatic charging function in accordance with an exemplary embodiment.

FIG. 2 is an exploded view of the wearable electronic device of FIG. 1.

FIG. 3 is a cross-sectional view of the wearable electronic device of FIG. 1, taken along the line of FIG. 1.

FIG. 4 is a circuit diagram of the wearable electronic device of FIG. 1.

### DETAILED DESCRIPTION

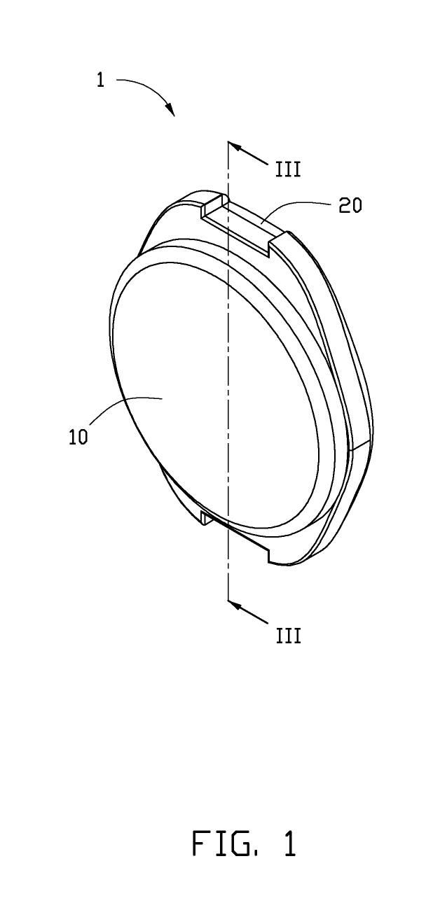

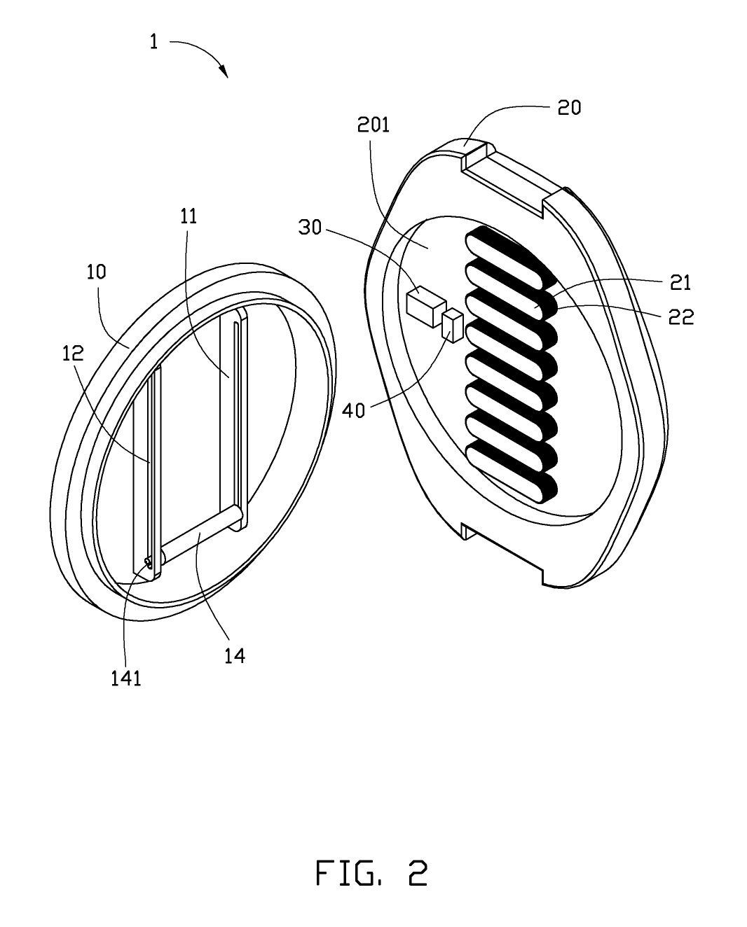

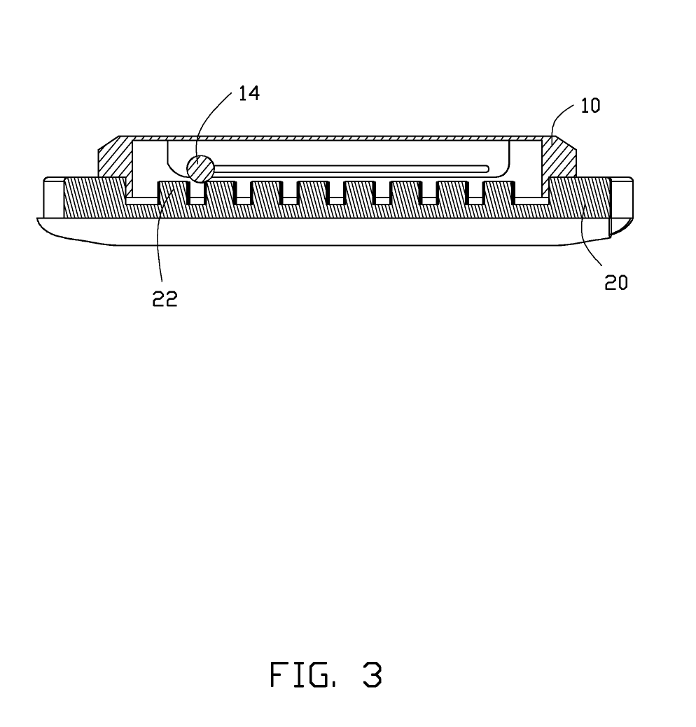

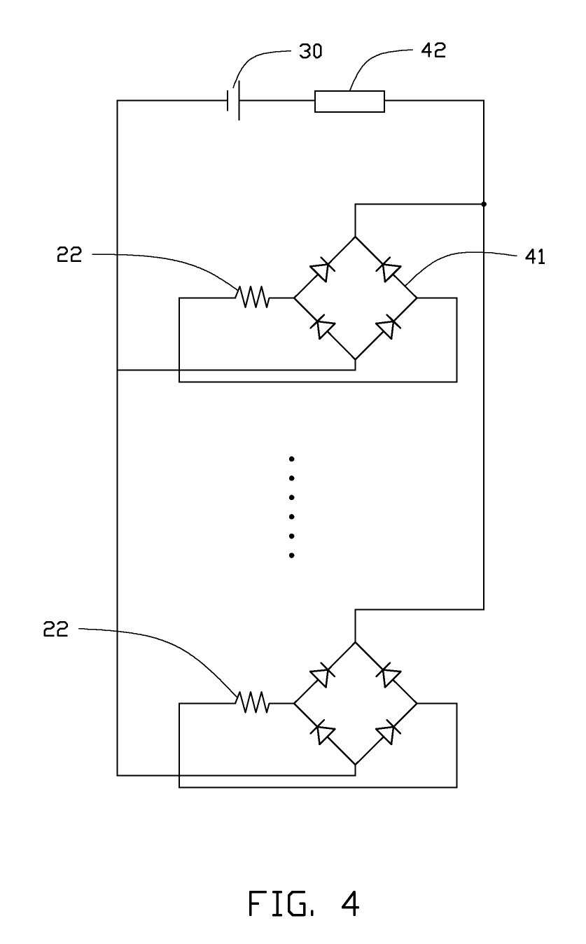

Referring to FIGS. 1-4, an embodiment of a wearable electronic device 1 is illustrated. The wearable electronic device 1 includes a rechargeable battery 30, a base 10, and a cover 20 engaged with the base 10, and a converting circuit 40. The cover 20 includes at least one conducting winding 22. Two ends of the at least one conducting winding 22 are electrically connected to the rechargeable battery 30. The wearable electronic device 1 further includes a magnet 14 slidably connected inside of the base 10. When the wearable electronic device 1 is moved by an external force, the magnet 14 is driven to slide inside of the base 10, the magnetic flux density passing through the at least one conducting winding 22 is changed, causing an induction current to be generated. Because the induction current is alternating current, the converting circuit 40 is able to convert the alternating current to direct current. The direct current is provided to the rechargeable battery 30. In order to better understand the disclosure, an exemplary embodiment is described in detail.

The cover 20 is elliptical, and defines a recessed portion 201 in its inner surface. A numbers of posts 21 protrude from the recessed portion 201. The at least one conducting winding 22 is coiled around each post 21. In one embodiment, the post 21 is made of material which can intensify the magnetic flux density, such as silicon steel.

The base 10 is a rounded plate. Two opposite side plates 11 protrude from the inner surface of the base 10. The two side plates 11 respectively define a sliding groove 12 along a lengthwise direction thereof.

The magnet 14 includes two extending portions 141 extending from two opposite ends thereof. The two extending portions 141 are slidably connected to the two sliding grooves 12, causing the magnet 14 to be able to slide along the sliding grooves 12. In one embodiment, the magnet 14 is cylindrical.

When the wearable electronic device 1 is wore over an arm of a user, and the user shakes the arm, the magnet 14 will slide along the sliding grooves 12 together with the shake of the wearable electronic device 1. During slide of the magnet 14, the magnetic flux density passing through the conducting winding 22 is changed, causing an induction current to be generated.

The converting circuit 40 is electrically connected between the at least one conducting winding 22 and the rechargeable battery 30, and is able to converting the alternating current to the direct current. In one embodiment, the converting circuit 40 includes a first converting circuit 41 and a second converting circuit 42.

The first converting circuit 41 is electrically connected to two ends of each conducting winding 22, and is able to converting the induction current to an erratic direct current.

The second converting circuit 42 is electrically connected to the rechargeable battery 30, and is able to convert the erratic direct current to a steady direct current.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A wearable electronic device with an automatic rechargeable function, comprising:
a rechargeable battery being able to supply power for the wearable electronic device;
a base;
a cover engaged with the base, and comprising at least one conducting winding electrically connected to the rechargeable battery;
a converting circuit; and
a magnet slidably connected to inside of the base;
wherein when the wearable electronic device is moved to drive the magnet to slide inside of the base, the magnetic flux density passing through the at least one conducting winding is changed, causing an induction current to be generated, the converting circuit is able to convert the induction current to direct current to charge the rechargeable battery.

2. The wearable electronic device as described in claim 1, wherein the cover defines a recessed portion, a plurality of posts protrude from the recessed portion, the at least one conducting winding is coiled around the plurality of posts.

3. The wearable electronic device as descried in claim 1, wherein two opposite side plates protrude from an inner surface of the base, and respectively defines a sliding grooves along a lengthwise direction thereof, the magnet comprises two extending portions extending from two opposite ends thereof, the two extending portions are respectively slidably connected to the sliding grooves.

4. The wearable electronic device as described in claim 1, wherein the magnet is cylindrical.

5. The wearable electronic device as described in claim 2, wherein the post is made of silicon steel material.

6. The wearable electronic device as described in claim 1, wherein the converting circuit comprises a first converting circuit and a second converting circuit, the first converting circuit is electrically connected two ends of each conducting winding, and is able to converting the induction current to an erratic direct current, and the second converting circuit is electrically connected to the rechargeable battery, and is able to convert the erratic direct current to a steady direct current.
